(19) United States
(12) Patent Application Publication
(10) Pub. No.: US 2025/0360904 A1
(43) Pub. Date: Nov. 27, 2025

(54) ACTUATOR FOR AN ELECTROMECHANICAL VEHICLE BRAKE SYSTEM AND ELECTROMECHANICAL VEHICLE BRAKE SYSTEM

(71) Applicant: HELLA GmbH & Co. KGaA, Lippstadt (DE)

(72) Inventor: Joachim FUNKE, Otzberg (DE)

(73) Assignee: HELLA GmbH & Co. KGaA, Lippstadt (DE)

(21) Appl. No.: 19/214,692

(22) Filed: May 21, 2025

(30) Foreign Application Priority Data
May 22, 2024 (DE) 10 2024 114 290.1

(51) Int. Cl. B60T 13/74; F16D 65/18; F16D 121/24; F16D 125/36; F16D 125/48

(52) U.S. Cl. CPC B60T 13/746; F16D 65/18; F16D 2121/24; F16D 2125/36; F16D 2125/48

(57) ABSTRACT

An actuator for an electromechanical vehicle brake system with an electromechanically actuable service brake and an electromechanically actuable parking brake, an electric motor and a gearbox, which has first and second gear elements. The two gear elements are connected to one another in a torque-transmitting manner. The first gear element is rotatable about an axis of rotation and is translationally movable in the direction of the axis of rotation. The second gear element is rotatable about the axis of rotation and is fixed in the direction of the axis of rotation and is connected to the first gear element in a torque-transmitting manner via a connecting device. The gearbox has a parking brake coupling device which can be switched between an open state and a closed state and which has a first, rigidly arranged coupling element and a second coupling element which is operatively connected to the first gear element.

This nonprovisional application claims priority under 35 U.S.C. § 119(a) to German Patent Application No. 10 2024 114 290.1, which was filed in Germany on May 22, 2024, and which is herein incorporated by reference.

### BACKGROUND OF THE INVENTION

### Field of the Invention

The invention relates to an actuator for an electromechanical vehicle brake system with an electromechanically actuatable service brake and an electromechanically actuatable parking brake.

### Description of the Background Art

According to the conventional art, a vehicle usually has a service brake and a parking brake. The service brake is usually actuated by the driver using the brake pedal. Today, the parking brake is often made as a separate electromechanical actuator and is typically activated by the driver via a separate switch. The actuator for deploying the parking brake is usually attached to the brake caliper of a braking device and, in particular, prevents a parked vehicle from rolling away.

Further, it is known from the conventional art that the service brake is made as a so-called brake-by-wire brake system, wherein the actuation of the brake pedal is detected by a sensor device and, based on this, an electric motor of an actuator which interacts with the service brake is actuated. In particular, the brake pistons acting on the brake pads are translationally moved by the actuator, which causes the brake pads to move relative to a brake disk that is fixedly connected to a vehicle wheel and rotates together with the vehicle wheel during driving. As an alternative to the disk brake, the braking device can also be designed as a drum brake, wherein here as well, the brake pads are moved by an actuator as a function of the sensor signal from a sensor device that detects the actuation of the brake pedal, and a braking process is triggered thereby.

For example, an actuator for a vehicle brake system with an electromechanically actuatable service brake and an electromechanically actuatable parking brake is known from DE 10 2011 086 152 A1, wherein the connection of the drive pinion to various components is adjusted by moving a drive pinion of an electric motor and thereby is switched between a service braking function, a parking braking function, and a play compensation function. The drive pinion is adjusted by means of a plurality of coils which interact with an armature attached to a drive shaft of the electric motor to which the drive pinion is attached. In this regard, depending on the desired function, the corresponding coil is energized, causing a predefined magnetic field, wherein the armature, together with the drive shaft and the drive pinion, is translationally moved into the corresponding position by the resulting magnetic field. The disadvantage of such actuator designs is that additional coils with associated control functions are required in order to switch at least between the parking brake function and the service brake function. This in turn leads to relatively high assembly and manufacturing costs and to a relatively large actuator size.

### SUMMARY OF THE INVENTION

It is therefore an of the invention to provide an actuator for an electromechanical vehicle brake system for the reliable deployment of a service brake and a parking brake, which can be designed in a space-saving, simple, and cost-effective manner.

The actuator comprises at least one electric motor and a gearbox. The gearbox is interposed between the electric motor and a brake actuating unit, which interacts with a braking device, so that the gearbox is connected to the electric motor, i.e., to a drive pinion of the electric motor, on the drive side and to the brake actuating unit on the output side in a torque-transmitting manner.

The gearbox has at least two gear elements which are connected to each other in a torque-transmitting manner via a connecting device. The first gear element is mounted so as to be rotatable about an axis of rotation and translationally movable in the direction of the axis of rotation. The second gear element is arranged coaxially to the first gear element and is therefore mounted so as to be rotatable about the axis of rotation. In contrast to the first gear element, the second gear element is mounted in a translationally fixed manner in the direction of the axis of rotation, so that translational movement of the second gear element is not possible.

When the vehicle is in motion, actuation of the brake pedal is detected by a sensor device and the electric motor is controlled by a control unit according to the detected displacement of the brake pedal. The electric motor drives the gear wheel via the drive pinion, wherein due to the torque-transmitting connection, brought about by the connecting device, between the gear elements, the gear elements together rotate about the axis of rotation. The brake actuating unit, which is operatively connected to the second gear element, is usually operatively connected to two brake pads in such a way that the output-side rotary movement leads to a translational movement of the brake pads, whereby the brake disk, arranged between the brake pads, is clamped between the two brake pads and a braking effect is caused by the friction which is present between the brake disk and the brake pads and is dependent on the contact pressure.

The gearbox also has a parking brake coupling device which, together with other components, is used to implement a parking brake. The parking brake coupling device has two coupling elements. A first coupling element is rigidly arranged. A second coupling element is operatively connected to the first gear element in such a way that the second coupling element rotates and is translationally moved depending on the rotation and translational movement of the first gear element.

To activate the parking brake, the electric motor is controlled in such a way that a torque provided by the electric motor exceeds a predefined torque threshold, wherein exceeding the torque threshold is only possible if the brake pads are in contact with the brake disk or brake drum. The service brake is applied in a service brake torque range that is below the torque threshold. By increasing the torque provided by the electric motor, i.e., by a corresponding control of the electric motor, above the predefined torque threshold and a corresponding design of the connecting device, the first gear element moves in the direction of rotation and translationally in the direction of the axis of rotation relative to the second gear element. As a result of the second coupling element being operatively connected to the first gear element, the second coupling element is moved translationally relative to the stationary first coupling element in such a way that the parking brake coupling device is shifted from the open state to the closed state. The parking brake is activated when the parking brake coupling device is in the closed state.

In the open state, the coupling elements are separated from each other so that the actuator serves exclusively as a service brake. If a parking brake is activated when the vehicle is stationary, the actuator is used to activate the parking brake, wherein the parking brake coupling device is moved into the closed state by the corresponding control of the electric motor. The electric motor is inactive in the closed state, wherein the parking brake coupling device remains in the closed state due to a holding force, which is composed in particular of the static friction between components in contact with one another, in particular the coupling elements, the components of the connecting device, and the components of the actuating unit, and the cogging torque of the electric motor. The closed state is maintained until the first gear element is rotated in the opposite direction of rotation by the electric motor, and thereby the static friction is overcome and the cogging torque of the electric motor is eliminated.

As a result, an actuator for an electromechanical vehicle brake is provided, which enables a service brake function and a parking brake function and can be designed in a space-saving, simple, and cost-effective manner.

The parking brake coupling device can be a friction coupling, wherein both coupling elements each have a friction surface which surfaces rest against each other in the closed state and are spaced apart from each other in the open state. As a result, the parking brake coupling device can be simply designed and easily shifted between the open and closed state, wherein to provide the closed state, the two coupling elements only have to be moved translationally relative to each other until the two coupling elements are in contact with each other. The relative positions of the two coupling elements to each other in the direction of rotation do not have to be taken into account. Alternatively, the parking brake coupling device can be designed as a form-fit coupling, wherein the two coupling elements are positively connected to each other in the direction of rotation in the closed state. For example, the parking brake coupling device could be designed as a claw coupling.

The second coupling element can be manufactured in one piece with the first gear element. As a result, the coupling element can be formed by the gear wheel, wherein the second coupling element is co-manufactured during the production of the first gear element. As a result, the manufacturing and assembly costs of the actuator can be reduced. The first coupling element is preferably manufactured in one piece with an actuator housing. Alternatively, the first coupling element is a separate element and is attached to the actuator housing.

A spring element can be provided which is designed and arranged in such a way that the two coupling elements are pressed apart by the spring element. Preferably, the spring element is arranged between the first gear element and an actuator housing, wherein the first coupling element is arranged on the actuator housing. It is reliably prevented thereby that the coupling elements come into contact with each other in the open position. When the parking brake is activated, the axial force caused by the connecting device and the torque of the electric motor, i.e., the force in the direction of the axis of rotation, exceeds the spring force of the spring element, causing the coupling elements to be moved relative to each other, i.e., towards each other. The spring force is so low that when the parking brake coupling device is closed, the spring force is not high enough to move the coupling parts apart

The gear elements each form a gear wheel, wherein the first gear element can be connected to a drive pinion of the electric motor and the second gear element can be connected to a third gear element, which is formed as a gear wheel and is operatively connected to a brake actuating unit. Also, the second gear element can be connected directly to the brake actuating unit.

One of the gear elements can have a bearing section on which the other gear element is mounted so as to be movable in the direction of rotation and in the direction of the axis of rotation. As a result, the second gear element serves to support the first gear element, which can reduce the manufacturing and assembly costs of the actuator, because no additional component or no additional design, for example, of the actuator housing, is required to support the first gear component.

The connecting device can be arranged in the direction of the axis of rotation between the two gear elements. In a preferred embodiment, the connecting device is formed by at least one pocket formed on the first gear element, a counter-pocket formed on the second gear element, and a rolling element, preferably a ball or a cylinder, arranged in the pocket and in the counter-pocket, wherein the pocket and/or the counter-pocket have a ramp-like side wall such that when the predefined torque threshold is exceeded, the rolling element moves out of the pocket and/or counter-pocket along the ramp-like side wall in such a way that the two gear elements are moved relative to one another in the direction of the axis of rotation and in the direction of rotation.

When the electric motor is operated in the service braking torque range, the at least one rolling element remains in the pocket and in the counter-pocket due to the relatively steep ramp-like side wall, so that the two gear elements rotate together during the service braking function and there is no relative movement between the gear elements. Only when the predefined torque threshold is exceeded by the torque to be transmitted via the gear elements by activating the electric motor accordingly is there a movement of the rolling elements along the ramp-like side wall of the pocket and/or the counter-pocket, whereby the first gear element moves in the direction of rotation and in the direction of the axis of rotation relative to the second gear element. The movement of the first gear element moves the second coupling element in the direction of the first coupling element and moves the parking brake coupling device into the closed state and thereby activates a parking brake function. By selecting the inclination, i.e., the angle to the horizontal, of the ramp-like side wall, the torque threshold and the holding force can be adjusted in the closed state of the parking brake coupling device.

The object is also achieved by an electromechanical vehicle brake system having an actuator and a braking device, wherein the actuator is operatively connected to at least one brake pad of the braking device via a brake actuating unit. The braking device can be either a disk brake or a drum brake.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an electromechanical vehicle brake system in cross section, and

FIG. 2 shows a detail of a connecting device of an actuator of the electromechanical vehicle brake system

### DETAILED DESCRIPTION

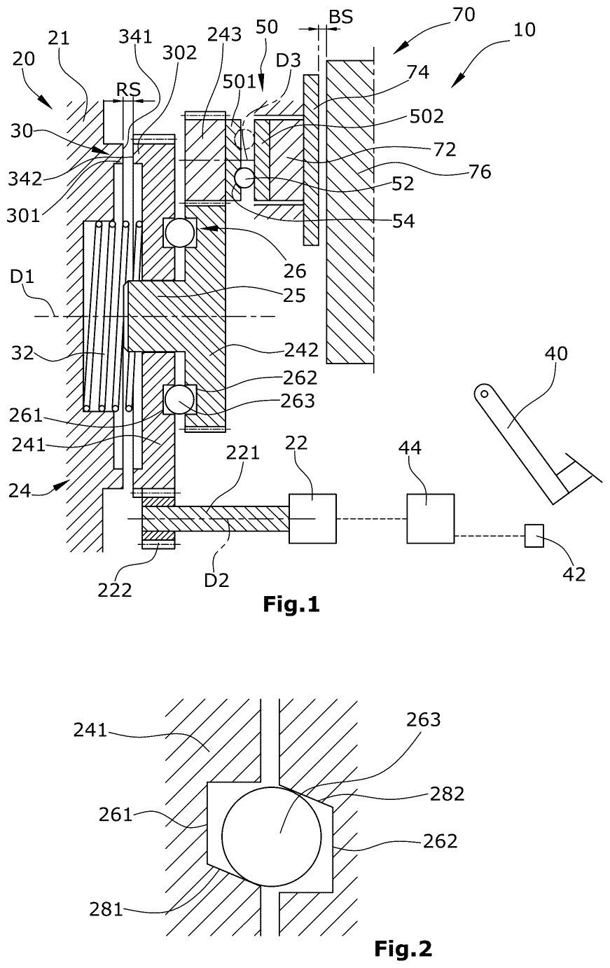

FIG. 1 shows an electromechanical vehicle brake system 10. The electromechanical vehicle brake system 10 comprises an actuator 20, a brake actuating unit 50, and a braking device 70. The electromechanical vehicle brake system 10 is designed as a brake-by-wire system, wherein actuator 20 is controlled as a function of the position of a brake pedal 40. The position of brake pedal 40 is detected by a sensor device 42, wherein the sensor signals of sensor device 42 are processed in a control unit 44 and used to operate actuator 20.

Actuator 20 has an electric motor 22 and a gearbox 24. Electric motor 22 comprises a stator and a rotor, wherein the stator is fastened, for example, to an actuator housing 21 and the rotor is mounted on actuator housing 21 so as to be rotatable about an axis of rotation D2. Rotor is nonrotatably connected to a drive shaft 221, wherein a drive pinion 222 is arranged nonrotatably on drive shaft 221, so that drive pinion 222 is driven via drive shaft 221. Electric motor 22, i.e., the stator, is electrically connected to control unit 44, so that electric motor 22 is controlled by control unit 44.

Gearbox 24 is interposed between electric motor 22 and brake actuating unit 50, so that gearbox 24 is connected on the drive side to electric motor 22, i.e., to drive pinion 222 of electric motor 22, and on the output side to brake actuating unit 50 in a torque-transmitting manner.

Gearbox 24 has three gear elements 241, 242, 243. A first gear element 241 is designed as a gear wheel and meshes with drive pinion 222, so that first gear element 241 is driven by electric motor 22 during operation.

A second gear element 242 and a third gear element 243 are also designed as gear wheels. Second gear element 242 is arranged coaxially to first gear element 241 and is connected to first gear element 241 in a torque-transmitting manner via a connecting device 26, wherein second gear element 242 meshes with third gear element 243. Gear element 243 is operatively connected to actuating unit 50.

First gear element 241 is rotatable about an axis of rotation D1 and is mounted translationally in the direction of the axis of rotation D1 on a bearing section 25 of second gear element 242. Second gear element 242 can be rotated about the axis of rotation D1 and is mounted on actuator housing 21 so as to be fixed in the direction of the axis of rotation D1. Third gear element 243 is rotatable about an axis of rotation D3 and is mounted on actuator housing 21 so as to be fixed in the direction of the axis of rotation D3.

Connecting device 26 connecting the two gear elements 241, 243 in a torque-transmitting manner is arranged in the direction of the axis of rotation D1 between the two gear elements 241, 242 and has a plurality of pockets 261 formed on first gear element 241 and distributed in the circumferential direction, a plurality of counter-pockets 262 formed on second gear element 242 and distributed in the circumferential direction, and a plurality of rolling elements 263, in particular spherical rolling elements, each arranged in a pocket 261 and in a counter-pocket 262.

A detail of connecting device 26 is shown in FIG. 2. Pockets 261 and counter pockets 262 are groove-like, wherein one side wall 281, 282 of each of the pockets 261 and counter-pockets 262 is designed in the form of a ramp. When providing a braking function of braking device 70, rolling elements 263 are in contact with these side walls 281, 282.

Gearbox 24 also has a parking brake coupling device 30, which can be switched between an open state and a closed state. Parking brake coupling device 30 comprises two coupling elements 301, 302. A first coupling element 301 is rigidly arranged on actuator housing 21 and has an annular friction surface 341. A second coupling element 302 is integrally formed with first gear element 241 and has an annular friction surface 342, which faces first coupling element 301. In the open state, the two coupling elements 301, 302 are spaced apart from one another and there is a gap RS between the friction surfaces of coupling elements 301, 302. The two coupling elements 301, 302 are pressed apart by a spring element 32 to maintain the gap RS in the open state, wherein spring element 32 is arranged between first gear element 241 and actuator housing 21. In the closed state, the gap RS is no longer present and coupling elements 301, 302 are in contact with each other via friction surfaces 341, 342.

Brake actuating unit 50 comprises two actuating elements 501, 502 and a plurality of spherical rolling elements 52 connecting actuating elements 501, 502 with one another. First actuating element 501 is nonrotatably connected to third gear element 243 and has a plurality of actuating pockets 54, which are ramp-like in the circumferential direction and in which rolling elements 52 are arranged. Second actuating element 502 is mounted so that it can be moved translationally and rests against rolling elements 52 with a side facing third gear element 243. With a side facing away from third gear element 243, second actuating element 502 is connected to a brake piston 72 of braking device 70, which piston is designed as a disk brake and is also mounted so as to be translationally movable. Brake piston 72 is fixedly connected to a brake pad 74, wherein brake pad 74 interacts with a brake disk 76 of braking device 70 for a braking function.

In the normal driving mode of the vehicle, in which the service brake is required, actuation of brake pedal 40 is detected by sensor device 42 and, based on this, electric motor 22 is controlled by control unit 44 in accordance with the detected deflection of brake pedal 40. Electric motor 22 drives first gear element 241 via drive pinion 222, wherein connecting device 26 causes gear elements 241, 242 to rotate together about the axis of rotation D1. Third gear element 243 is driven by second gear element 242, wherein first actuating element 501 also rotates together with third gear element 243. First actuating element 501 is rotated by the rotary movement of first actuating element 501 in such a way that rolling elements 52 move along the ramp-like actuating pockets 54, causing second actuating element 502, brake piston 72, and brake pad 74 to be moved translationally. As soon as a distance BS has been overcome, brake pad 74 is in contact with brake disk 76 and a braking effect is present. The braking effect is caused by the friction between brake disk 76 and brake pad 74, which is dependent on the contact pressure, i.e., on the torque provided by electric motor 22. The service brake function can be provided by controlling electric motor 22 in a service brake torque range.

To activate the parking brake, electric motor 22 is controlled in such a way that a torque provided by electric motor 22 exceeds a predefined torque threshold, wherein the torque threshold can only be provided when brake pads 74 are in contact with brake disk 76. When electric motor 22 is operated in the service brake torque range, i.e., below the torque threshold relevant for the parking brake, rolling elements 263 remain in pockets 261 and in counter-pockets 262 due to the relatively steep ramp-like side wall, so that the two gear elements 241, 242 rotate together during the service brake function and no relative movement takes place between gear elements 241, 242. Only when the predefined torque threshold is exceeded by the torque to be transmitted via gear elements 241, 242, by controlling electric motor 22 accordingly, does this result in a movement of rolling elements 263 along the ramp-like side wall of pockets 261 and counter-pockets 262, whereby first gear element 241 moves in the direction of rotation and in the direction of the axis of rotation D1 relative to second gear element 242. By moving first gear element 241 in the direction of the axis of rotation D1, second coupling element 302 is moved in the direction of first coupling element 301 and parking brake coupling device 30 is shifted to the closed state. As a result, a parking brake function is activated.

When the parking brake coupling device 30 has been shifted to the closed state, electric motor 22 can be switched to an inactive state. Due to the existing static friction between the components in contact with one another, in particular coupling elements 301, 302, the components of connecting device 26 and the components of actuating unit 50, and due to the cogging torque of electric motor 22, the parking brake function is maintained even when electric motor 22 is inactive. The parking brake function is maintained until first gear element 241 is turned in an opposite direction of rotation by electric motor 22, whereby the static friction is overcome and the cogging torque of electric motor 22 is canceled.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An actuator for an electromechanical vehicle brake system comprising an electromechanically actuable service brake and an electromechanically actuable parking brake, the actuator comprising:
an electric motor; and
a gearbox that has at least one first gear element and a second gear element, the first and second gear elements being connected to one another in a torque-transmitting manner,
wherein the first gear element is rotatable about an axis of rotation and is translationally movable in a direction of the axis of rotation, and the second gear element is rotatable about the axis of rotation and is fixed in the direction of the axis of rotation and is connected to the first gear element in a torque-transmitting manner via a connecting device;
wherein the gearbox has a parking brake coupling device that is adapted to be switched between an open state and a closed state and that has a first, rigidly arranged coupling element and a second coupling element that is operatively connected to the first gear element,
wherein the connecting device is designed such that above a predefined torque threshold, the first gear element is moved relative to the second gear element in the direction of rotation and in the direction of the axis of rotation such that the second coupling element, which is operatively connected to the first gear element, is moved relative to the first coupling element in the direction of the axis of rotation such that the parking brake coupling device is switched between the open state and the closed state.

2. The actuator according to claim 1, wherein the parking brake coupling device is a friction coupling, wherein both coupling elements each have friction surface, which surfaces rest against each other in the closed state and are spaced apart from each other in the open state.

3. The actuator according to claim 1, wherein the second coupling element is manufactured in one piece with the first gear element.

4. The actuator according to claim 1, wherein the first coupling element is attached to an actuator housing or is manufactured in one piece with the actuator housing.

5. The actuator according to claim 1, wherein a spring element is provided which is designed and arranged in such a way that the two coupling elements are pressed apart by the spring element.

6. The actuator according to claim 1, wherein the gear elements each form a gear wheel, wherein the first gear element is connected to a drive pinion of the electric motor and the second gear element is connected to a third gear element which is formed as a gear wheel and is operatively connected to a brake actuating unit.

7. The actuator according to claim 1, wherein one of the gear elements has a bearing section on which the other gear element is mounted so as to be movable in the direction of rotation and in the direction of the axis of rotation.

8. The actuator according to claim 1, wherein the connecting device is arranged in the direction of the axis of rotation between the two gear elements.

9. The actuator according to claim 8, wherein the connecting device is formed by at least one pocket formed on the first gear element, a counter-pocket formed on the second gear element, and a rolling element arranged in the pocket and in the counter-pocket, and wherein the pocket and/or the counter-pocket have a ramp-like side wall such that when the predefined torque threshold is exceeded, the rolling element moves along the ramp-like side wall such that the first and second gear elements are moved relative to one another in the direction of the axis of rotation and in the direction of rotation.

10. The actuator according to claim 9, wherein the rolling element is a ball or a cylinder.

11. The actuator according to claim 1, wherein the electric motor is inactive when the parking brake coupling device is in a closed state.

12. An electromechanical vehicle brake system comprising:
an actuator according to claim 1; and
a braking device,
wherein the actuator is operatively connected to at least one brake pad of the braking device via a brake actuating unit.
